(19) United States
(12) Patent Application Publication
(10) Pub. No.: US 2015/0095632 A1
(43) Pub. Date: Apr. 2, 2015

(54) COMPUTER BOOTING SYSTEM AND METHOD FOR COMPUTER SYSTEM

(71) Applicants: HON HAI PRECISION INDUSTRY CO., LTD., New Taipei (TW); HONG FU JIN PRECISION INDUSTRY (WuHan) CO., LTD., Wuhan (CN)

(72) Inventors: HUNG-CHI HUANG, New Taipei (TW); CHING-JOU CHEN, New Taipei (TW)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 14/059,515

(22) Filed: Oct. 22, 2013

(30) Foreign Application Priority Data
Sep. 30, 2013 (TW) 102135441

(51) Int. Cl. G06F 11/14

(52) U.S. Cl. CPC G06F 11/1417
USPC 713/2

(57) ABSTRACT

In a computer booting method for a computer system, the computer system includes a serial peripheral interface (SPI) ROM and a supper I/O (SIO) controller. The method initializes a backup BIOS booting block of the SIO controller when the computer system is powered on, and detects whether an original BIOS booting block of the SPI ROM is damaged. A memory address for obtaining the backup BIOS booting block is changed from the SPI ROM to the SIO controller when the original BIOS booting block of the SPI ROM is damaged. The method further restarts the computer system, and executes a main BIOS of the SPI ROM to perform a power-on self test (POST) procedure of the computer system using the backup BIOS booting block of the SIO controller, to make sure that the computer system boots normally.

### BACKGROUND

1. Technical Field

Embodiments of the present disclosure relate to computer booting systems and methods, and particularly to a computer booting system and method for a computer system.

2. Description of Related Art

While booting a computer system, a basic input/output system (BIOS) of the computer system is initiated. When the BIOS is executed, a power-on self test (POST) is performed to make sure that hardware of the computer system can be normally operated. When the POST is finished, the BIOS tries to read a sector of the hard disk which is called the master boot record (MBR). The data in the MBR are loaded into a memory to be executed, and then data provided by an operating system (OS) is loaded to enter the operating system.

If errors occur in the BIOS, the BIOS stored in a flash memory of the computer system needs to be updated to boot the computer system normally. However, it is difficult or problematic to update the BIOS if main program codes of the BIOS are damaged. Thus, the computer system needs to be sent back to the original manufacturer to update the BIOS.

### BRIEF DESCRIPTION OF THE DRAWINGS

FIG. 1 is a block diagram of one embodiment of a computer system including a computer booting system.

FIG. 2 is a block diagram illustrating function modules of the computer booting system of FIG. 1.

FIG. 3 is a flowchart of one embodiment of a computer booting method for the computer system.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In the present disclosure, the word “module,” as used herein, refers to logic embodied in hardware or firmware, or to a collection of software instructions, written in a program language. In one embodiment, the program language may be Java, C, or assembly. One or more software instructions in the modules may be embedded in firmware, such as in an EPROM. The modules described herein may be implemented as either software and/or hardware modules and may be stored in any type of non-transitory computer-readable media or storage medium. Some non-limiting examples of a non-transitory computer-readable medium include CDs, DVDs, flash memory, and hard disk drives.

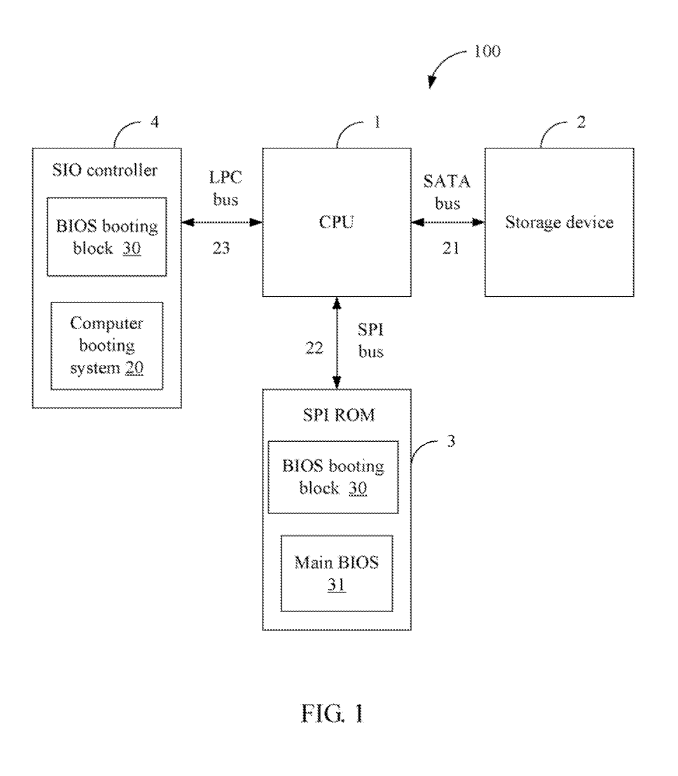

FIG. 1 is a block diagram of one embodiment of a computer system 100 including a computer booting system 20. In the embodiment, the computer booting system 10 is embedded in a supper I/O (SIO) controller 4, and is implemented by the computer system 100. The host computer system 1 includes, but is not limited to, at least one processor 1, a storage device 2, a serial peripheral interface (SPI) ROM 3, and the SIO controller 4. The storage device 2 connects to the processor 1 through a serial advanced technology attachment (SATA) bus 21, the SPI ROM 3 connects to the processor 1 through a SPI bus, and the SIO controller 4 connects to the processor 1 through a low pin count (LPC) bus 23. In one embodiment, the computer system 100 may be a personal computer, a server computer, a workstation computer, a notebook computer, or other computing device.

The at least one processor 1 is a central processing unit (CPU) or microprocessor that performs various functions of the computer system 100. In one embodiment, the storage device 2 may be an internal storage system, such as a flash memory, a random access memory (RAM) for temporary storage of information, and/or a read only memory (ROM) for permanent storage of information. The storage device 2 may also be an external storage system, such as an external hard disk, a storage card, or a data storage medium.

The SPI ROM 3 is a flash memory that stores an original BIOS booting block 30 and a main BIOS 31. The original BIOS booting block 30 invokes the main BIOS 31 to perform a power-on self test (POST) for the computer system 100 when the computer system 100 is powered on. The main BIOS 31 is executed to perform the POST of the computer system 100 and loads an operating system (OS) of the computer system 100.

The SIO controller 4 is a supper I/O embedded controller located at a LPC chipset, and monitors and manages hardware of the computer system 100, including a hard disk drive (HDD), a printer, a power supply, a audio card, and a video card, through COM ports and serial ports. The SIO controller 4 stores a backup BIOS booting block 30, which is identical to the original BIOS booting block 30 stored in the SPI ROM 3. The backup BIOS booting block 30 of the SIO controller 4 invokes the main the BIOS 31 to perform the POST for the computer system 100 when the original BIOS booting block 30 of the SPI ROM 3 is damaged, so as to make sure that the computer system 100 boots normally.

In one embodiment, the computer booting system 20 may comprise computerized instructions in the form of one or more program codes that are embedded in a flash ROM of the SIO controller 4. The computer booting system 20 may also be stored in a non-transitory computer-readable medium such as the storage device 2. When the original BIOS booting block 30 of the SPI ROM 3 is damaged, the computer booting system 20 invokes the main the BIOS 31 to boot the computer system 100 normally using the backup BIOS booting block 30 of the SIO controller 4, and recovers the original BIOS booting block 30 of the SPI ROM 3 using the backup BIOS booting block 30 of the SIO controller 4.

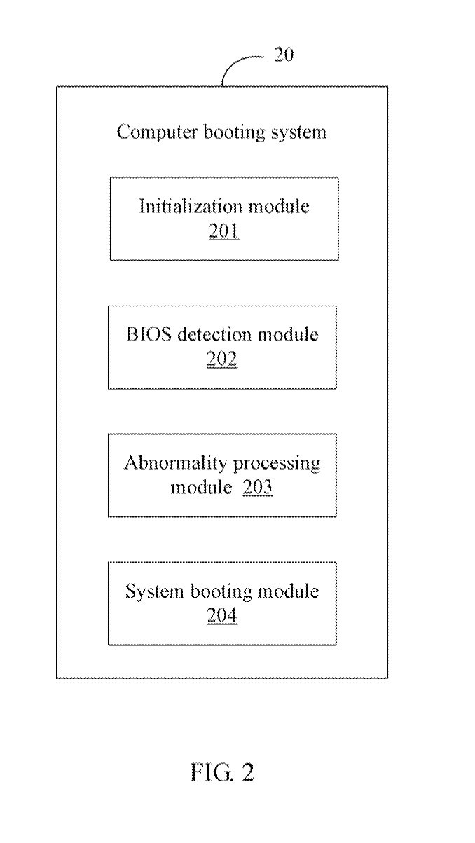

FIG. 2 is a block diagram illustrating function modules of the computer booting system 20. In the embodiment, the computer booting system 20 includes an initialization module 201, a BIOS detection module 202, an abnormality processing module 203, and a system booting module 204. The modules 201-204 may comprise computerized instructions in the form of one or more computer-readable programs that are stored in a non-transitory computer-readable medium (such as the storage device 2) and executed by the at least one processor 1. A description of each module is given in the following paragraphs.

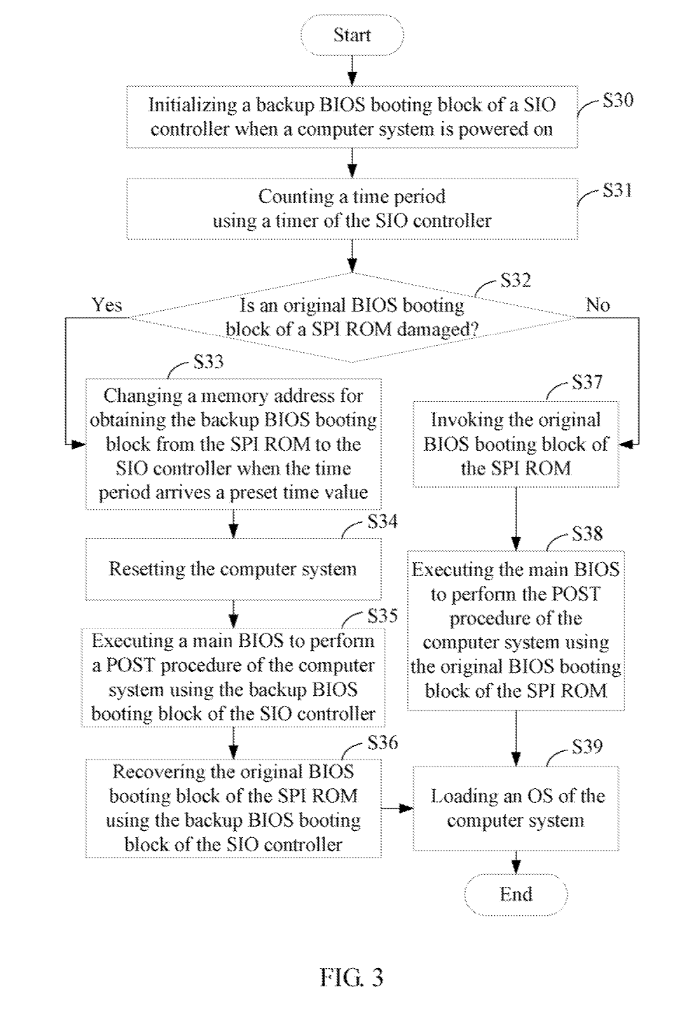

FIG. 3 is a flowchart of one embodiment of a computer booting method for the computer system 100. In the embodiment, the method is performed by execution of computer-readable software program codes or instructions by the at least one processor 1 of the computer system 100. Depending on the embodiment, additional steps may be added, others removed, and the ordering of the steps may be changed.

In step S30, the initialization module 201 initializes the backup BIOS booting block 30 of the SIO controller 4 when the computer system 100 is powered on. In one embodiment, the backup BIOS booting block 30 of the SIO controller 4 is identical to the original BIOS booting block 30 of the SPI ROM 3, which may be a software program including computer systemized instructions or codes. The backup BIOS booting block 30 invokes the main BIOS 31 of the SPI ROM 3 to perform the POST of the computer system 100 when errors occur in the original BIOS booting block 30 of the SPI ROM 3.

In step S31, the initialization module 201 counts a time period using a timer of the SIO controller 3. In the embodiment, the timer may be a hardware monitor that counts the time period while the SIO controller 3 monitors the hardware of the computer system 100.

In step S32, the BIOS detection module 202 detects whether the original BIOS booting block 30 of the SPI ROM 3 is damaged. In the embodiment, the BIOS detection module 202 detects whether the original BIOS booting block 30 of the SPI ROM 3 is damaged by determining whether the time period equals to a preset time value such as 30 seconds. The computer system 100 does not boot normally when the time period equals to the preset time value, the BIOS detection module 202 determines that the original BIOS booting block 30 of the SPI ROM 3 is damaged. If the original BIOS booting block 30 of the SPI ROM 3 is damaged, step S33 is implemented. Otherwise, if the original BIOS booting block 30 of the SPI ROM 3 is not damaged, step S37 is implemented.

In step S33, the BIOS detection module 202 changes a memory address for obtaining the backup BIOS booting block 30 from the SPI ROM 3 to the SIO controller 4 when the time period arrives the preset time value. In the embodiment, the memory address identifies a physical location of the backup BIOS booting block 30. For example, the memory address is 0x000000FF when the original BIOS booting block 30 is obtained from the SPI ROM 3, and the memory address is 0x000000EF when the backup BIOS booting block 30 is obtained from the SIO controller 4.

In step S34, the abnormality processing module 203 resets a power button of the computer system 100 to restart the computer system 100. In step S35, the abnormality processing module 203 executes the main BIOS 31 of the SPI ROM 3 to perform the POST procedure of the computer system using the backup BIOS booting block 30 of the SIO controller 4. In step S36, the abnormality processing module 203 recovers the original BIOS booting block 30 of the SPI ROM 3 using the backup BIOS booting block 30 of the SIO controller 4.

In step S37, the system booting module 204 invokes the original BIOS booting block 30 of the SPI ROM 3. In step S38, the system booting module 204 executes the main BIOS 31 to perform the POST procedure of the computer system 100 using the original BIOS booting block 30 of the SPI ROM 3. In step S39, the system booting module 204 controls the computer system 100 to enter an OS (such as a WINDOWS OS or a LUNIX OS) of the computer system 100, and completes the booting procedure of the computer system 100.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A computer system, comprising:
a serial peripheral interface (SPI) ROM that stores an original BIOS booting block and a main BIOS;
a supper I/O (SIO) controller that stores a backup BIOS booting block;
a storage device storing a computer-readable program including instructions that, which when executed by at least one processor, causes the at least one processor to:
initialize the backup BIOS booting block of the SIO controller when the computer system is powered on;
detect whether the original BIOS booting block of the SPI ROM is damaged;
change a memory address for obtaining the backup BIOS booting block from the SPI ROM to the SIO controller when the original BIOS booting block of the SPI ROM is damaged;
restart the computer system; and
execute the main BIOS of the SPI ROM to perform a power-on self test (POST) procedure of the computer system using the backup BIOS booting block of the SIO controller.

2. The computer system according to claim 1, wherein the computer-readable program further causes the at least one processor to:
invoke the original BIOS booting block of the SPI ROM when the original BIOS booting block of the SPI ROM is not damaged;
execute the main BIOS to perform the POST procedure of the computer system using the original BIOS booting block of the SPI ROM; and
control the computer system to enter an operating system (OS) of the computer system.

3. The computer system according to claim 1, wherein the computer-readable program further causes the at least one processor to:
recover the original BIOS booting block of the SPI ROM using the backup BIOS booting block of the SIO controller when the original BIOS booting block is damaged.

4. The computer system according to claim 1, wherein the computer-readable program further causes the at least one processor to:
count a time period using a timer of the SIO controller;
determine whether the time period equals to a preset time value to detect whether the original BIOS booting block of the SPI ROM is damaged; and
determine that the original BIOS booting block of the SPI ROM is damaged when the time period equals to the preset time value.

5. The computer system according to claim 1, wherein the SIO controller is a supper I/O embedded controller located at low pin count (LPC) chipset, and monitors and manages hardware of the computer system through one or more COM ports and serial ports.

6. The computer system according to claim 1, wherein the backup BIOS booting block of the SIO controller is identical to the original BIOS booting block of the SPI ROM, and invokes the main BIOS of the SPI ROM to perform the POST of the computer system when the original BIOS booting block of the SPI ROM is damaged.

7. A computer booting method for a computer system, the computer system comprising a serial peripheral interface (SPI) ROM and a supper I/O (SIO) controller, the method comprising:
initializing a backup BIOS booting block of the SIO controller when the computer system is powered on;
detecting whether an original BIOS booting block of the SPI ROM is damaged;
changing a memory address for obtaining the backup BIOS booting block from the SPI ROM to the SIO controller when the original BIOS booting block of the SPI ROM is damaged;
restarting the computer system; and
executing a main BIOS of the SPI ROM to perform a power-on self test (POST) procedure of the computer system using the backup BIOS booting block of the SIO controller.

8. The method according to claim 7, further comprising:
invoking the original BIOS booting block of the SPI ROM when the original BIOS booting block of the SPI ROM is not damaged;
executing the main BIOS to perform the POST procedure of the computer system using the original BIOS booting block of the SPI ROM; and
controlling the computer system to enter an operating system (OS) of the computer system.

9. The method according to claim 7, further comprising:
recovering the original BIOS booting block of the SPI ROM using the backup BIOS booting block of the SIO controller when the original BIOS booting block is damaged.

10. The method according to claim 7, further comprising:
counting a time period using a timer of the SIO controller;
determining whether the time period equals to a preset time value to detect whether the original BIOS booting block of the SPI ROM is damaged; and
determining that the original BIOS booting block of the SPI ROM is damaged when the time period equals to the preset time value.

11. The method according to claim 7, wherein the SIO controller is a supper I/O embedded controller located at low pin count (LPC) chipset, and monitors and manages hardware of the computer system through one or more COM ports and serial ports.

12. The method according to claim 7, wherein the backup BIOS booting block of the SIO controller is identical to the original BIOS booting block of the SPI ROM, and invokes the main BIOS of the SPI ROM to perform the POST of the computer system when the original BIOS booting block of the SPI ROM is damaged.

13. A non-transitory storage medium having stored thereon instructions that, when executed by at least one processor of a computer system, cause the computer system to perform a computer booting method, the computer system comprising a serial peripheral interface (SPI) ROM and a supper I/O (SIO) controller, the method comprising:
initializing a backup BIOS booting block of the SIO controller when the computer system is powered on;
detecting whether an original BIOS booting block of the SPI ROM is damaged;
changing a memory address for obtaining the backup BIOS booting block from the SPI ROM to the SIO controller when the original BIOS booting block of the SPI ROM is damaged;
restarting the computer system; and
executing a main BIOS of the SPI ROM to perform a power-on self test (POST) procedure of the computer system using the backup BIOS booting block of the SIO controller.

14. The storage medium according to claim 13, wherein the method further comprises:
invoking the original BIOS booting block of the SPI ROM when the original BIOS booting block of the SPI ROM is not damaged;
executing the main BIOS to perform the POST procedure of the computer system using the original BIOS booting block of the SPI ROM; and
controlling the computer system to enter an operating system (OS) of the computer system.

15. The storage medium according to claim 13, wherein the method further comprises:
recovering the original BIOS booting block of the SPI ROM using the backup BIOS booting block of the SIO controller when the original BIOS booting block is damaged.

16. The storage medium according to claim 13, wherein the method further comprises:
counting a time period using a timer of the SIO controller;
determining whether the time period equals to a preset time value to detect whether the original BIOS booting block of the SPI ROM is damaged; and
determining that the original BIOS booting block of the SPI ROM is damaged when the time period equals to the preset time value.

17. The storage medium according to claim 13, wherein the SIO controller is a supper I/O embedded controller located at low pin count (LPC) chipset, and monitors and manages hardware of the computer system through one or more COM ports and serial ports.

18. The storage medium according to claim 13, wherein the backup BIOS booting block of the SIO controller is identical to the original BIOS booting block of the SPI ROM, and invokes the main BIOS of the SPI ROM to perform the POST of the computer system when the original BIOS booting block of the SPI ROM is damaged.
